(19) United States
(12) Patent Application Publication
(10) Pub. No.: US 2025/0175999 A1
(43) Pub. Date: May 29, 2025

(54) MULTIPLEXING MECHANISMS FOR SL PRS AND PSCCH TRANSMISSION

(71) Applicant: Intel Corporation, Santa Clara, CA (US)

(72) Inventors: Gang Xiong, Beaverton, OR (US); Debdeep Chatterjee, San Jose, CA (US); Kilian Roth, München (DE); Toufiqul Islam, Santa Clara, CA (US); Jihyun Lee, Santa Clara, CA (US)

(21) Appl. No.: 18/857,652

(22) PCT Filed: Jul. 3, 2023
(86) PCT No.: PCT/US2023/026844

§ 371 Date: Oct. 17, 2024

Related U.S. Application Data
(60) Provisional application No. 63/390,393, filed on Jul. 19, 2022.
(60) Provisional application No. 63/422,367, filed on Nov. 3, 2022.

(51) Int. Cl. H04W 72/25; H04L 5/22; H04W 72/0446

(52) U.S. Cl. CPC H04W 72/25; H04L 5/22; H04W 72/0446

(57) ABSTRACT

An apparatus and system of providing a sidelink position reference signal (SL PRS) and Physical Sidelink Control Channel (PSCCH) transmission are described. The PSCCH, which carries sidelink control information (SCI), and SL PRS are time division multiplexed (TDMed) in a particular slot. The PSCCH is transmitted in a dedicated resource pool for SL PRS that includes a dedicated resource region allocated for the PSCCH transmission. The SL PRS is transmitted in a shared resource pool for SL communication and the SL PRS. A SL PRS resource index is indicated in a second stage SCI carried by a Physical Sidelink Shared Channel (PSSCH), which is TDMed with the PSCCH and the SL PRS. A starting symbol and/or length of the SL PRS is predefined in the 3 GPP specification or (pre-)configured by higher layer signaling.

### PRIORITY CLAIM

This application claims the benefit of priority to U.S. Provisional Patent Application Ser. No. 63/390,393, filed Jul. 19, 2022, and Provisional Patent Application Ser. No. 63/422,367, filed Nov. 3, 2022, each of which is incorporated herein by reference in its entirety.

### TECHNICAL FIELD

Embodiments pertain to sidelink communications in 3GPP networks. In particular, some embodiments relate to multiplexing of sidelink positioning reference signal and physical sidelink control channel transmissions in fifth generation (5G) and later networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to sidelink communications, for use in a wide variety developing applications.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates sidelink positioning in accordance with some embodiments.

FIG. 4 illustrates a Physical Sidelink Control Channel (PSCCH) transmission inside a sidelink position reference signal (SL PRS) resource for a user equipment (UE) in accordance with some embodiments.

FIG. 5 illustrates an example of multiplexing a PSCCH and SL PRS in a time domain multiplexing (TDM) manner in a SL-PSR resource pool in accordance with some embodiments.

FIG. 6 illustrates one example of multiplexing a PSCCH and a SL PRS in different slots in accordance with some embodiments.

FIG. 7 illustrates one example of multiplexing a PSCCH and a SL PRS in a SL PRS resource pool in accordance with some embodiments.

FIG. 8 illustrates one example of multiplexing a SL PRS with a PSSCH and a PSCCH in a shared resource pool in accordance with some embodiments.

FIG. 9 illustrates one example of collision handling between a SL PRS and a demodulation reference signal (DMRS) in a shared resource pool in accordance with some embodiments.

FIG. 10 illustrates one example of collision handling between a SL PRS and a DMRS in a shared resource pool in accordance with some embodiments.

FIG. 11 illustrates a flowchart of multiplexing a PSCCH and a SL PRS in a SL PRS resource pool in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

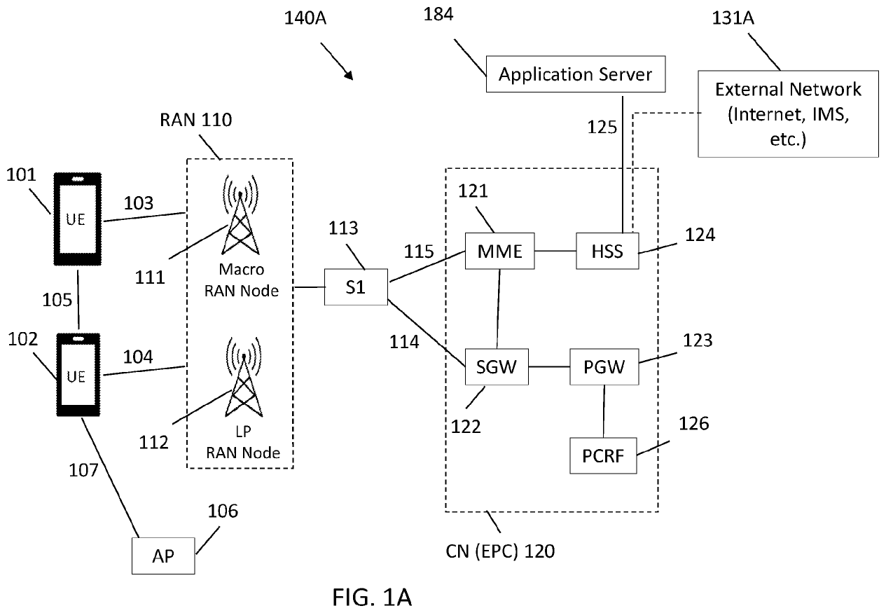

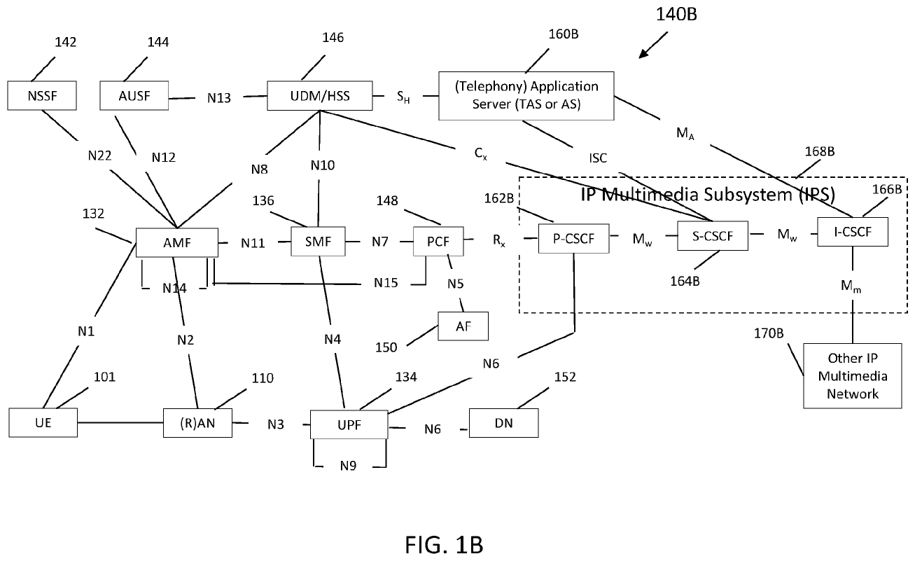

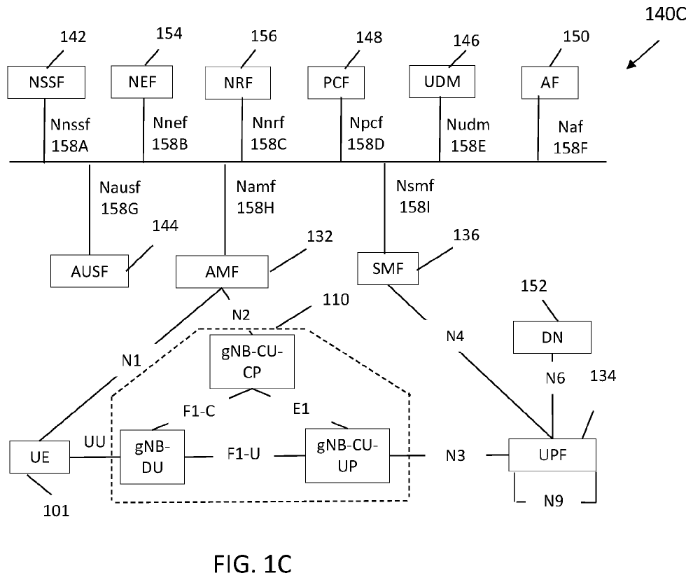

FIG. 1A illustrates an architecture of a network in accordance with some aspects. The network 140A includes 3GPP LTE/4G and NG network functions that may be extended to 6G and later generation functions. Accordingly, although 5G is referred to herein, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The El interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

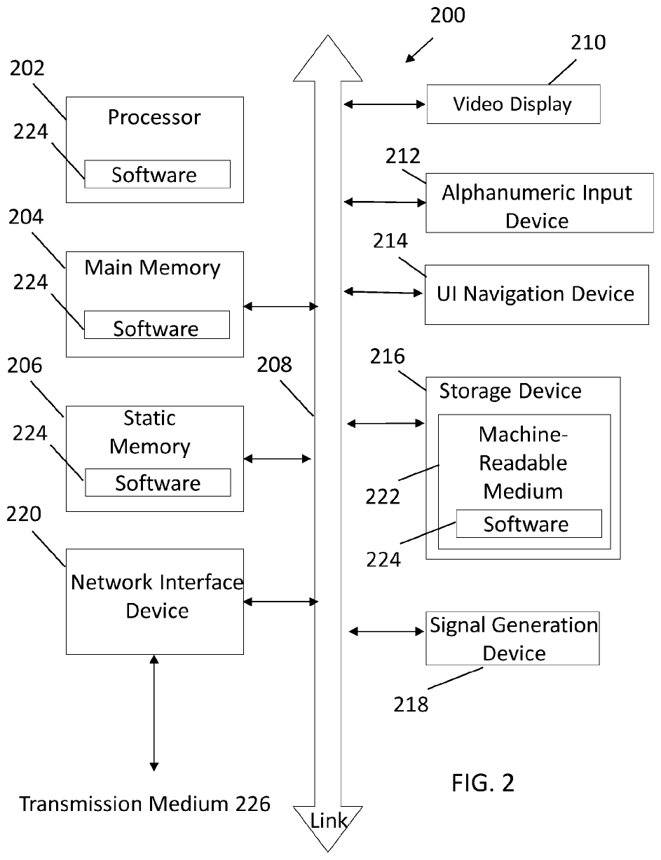

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., lowithmedium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

As above, mobile communication has evolved significantly from early voice systems to the modern highly sophisticated integrated communication platforms used in the current generation of the network. The next generation wireless communication system, 5G, or new radio (NR) is expected to provide access to information and sharing of data anywhere, anytime by an increasing number and type of users and applications. NR is to be a unified network/system whose target is to meet vastly different and sometime conflicting performance dimensions and services. Such diverse multi-dimensional requirements are driven by different services and applications.

NR supports a wide range of applications that may desire highly precise positioning in the vertical and horizontal dimensions. Such positioning may rely on timing-based, angle-based, power-based, and/or hybrid techniques to estimate the user (UE) location in the network. In particular, the following radio access technology (RAT)-dependent positioning techniques may be used to meet the positioning requirements for various use cases, e.g., indoor, outdoor, Industrial internet of thing (IoT), etc.: Downlink time difference of arrival (DL-TDOA), Uplink time difference of arrival (UL-TDOA), Downlink angle of departure (DL-AoD), Uplink angle of arrival (UL AoA), Multi-cell round trip time (multi-RTT), NR enhanced cell ID (E-CID).

With wide bandwidth for positioning signal and beamforming capability in mmWave frequency bands (about 30 GHz to about 300 GHz), higher positioning accuracy can be achieved by RAT-dependent positioning techniques. In Rel-16, a downlink positioning reference signal (DL-PRS) and an uplink sounding reference signal (UL-SRS) for positioning were introduced as an enabler to achieve target performance characteristics.

In Rel-18, in order to address use cases such as autonomous driving, sidelink or vehicle-to-everything (V2X)-based positioning are considered. More specifically, various scenarios including in-coverage, partial coverage, out of network coverage are to be considered for sidelink positioning. To meet the positioning accuracy requirement, a new sidelink reference signal, i.e., a sidelink position reference signal (SL PRS) is introduced.

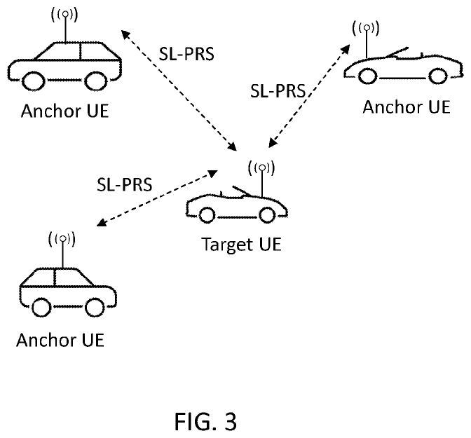

FIG. 3 illustrates sidelink positioning in accordance with some embodiments. The sidelink positioning in FIG. 3 includes anchor UEs and a target UE. In the example, the target UE indicates the UE to be positioned while the anchor UEs indicate the UEs supporting positioning of the target UE, e.g., by transmitting and/or receiving a SL PRS and providing positioning-related information (e.g., timing or power measurements, or distance or relative position from the transmitting UE). The SL PRS may be transmitted between the anchor and target UEs for sidelink positioning.

A SL PRS configuration may be configured by higher layers, while a sidelink control information (SCI) format may be used to allocate and reserve the resources for SL PRS transmission. To ensure proper resource allocation for SL PRS transmission, mechanisms on multiplexing between the physical sidelink control channel (PSCCH) carrying SCI and SL PRS transmission are defined below.

### Mechanisms on Multiplexing of SL PRS and PSCCH Transmission

In general, multiple SL PRS resources may be mapped to a resource pool for a SL PRS with or without further multiplexing with other SL channels within the resource pool. Different SL PRS resources may be multiplexed in time, frequency, or a combination thereof (e.g., using different comb offsets with repetitions or staggered assignments across OFDM symbols). Further, SL PRS resources may be indexed according to a specified order to identify different resources mapped to different time resources (symbols or slots), different physical resource blocks (PRBs), or different comb offsets, etc. In the following embodiments, a SL PRS resource pool may refer to a dedicated resource pool for SL PRS.

In one embodiment, a PSCCH carrying a SCI and a SL PRS may be multiplexed using a combination of time division multiplexing (TDM) and frequency division multiplexing (FDM) manner within a SL PRS dedicated resource pool. In particular, the PSCCH may occupy the resource allocated for a SL PRS resource. In some embodiments, different comb offsets may be used to identify different SL PRS resources. In this case, if different comb offsets are used to identify different SL PRS resources, the PSSCH may be transmitted using the same comb offset and occupying some or all of the resource elements (REs) as for a SL PRS transmission within a SL PRS dedicated resource pool. For this option, single port transmission may be used for both the SL PRS transmission and the PSCCH transmission.

For this option, for mode 2 resource allocation for SL PRS transmission, the UE may select a SL PRS resource based on the outcome of sensing and resource selection. In particular, the UE may allocate resources for initial SL PRS transmission and reserve up to Nᵣₑᵥ resources for the subsequent SL PRS transmissions, where Nᵣₑᵥ can be pre-defined in the specification or (pre-)configured by higher layers (that is, configured by higher layer signaling). Alternatively, sl-MaxNumPerReserve for SL communication may be reused for the maximum number of reserved resources for SL PRS transmission. In yet another example of SL PRS resource reservation, when configured with repetitions for the SL PRS transmission, each of the Nᵣₑᵥ resources may correspond to a number of repetitions of the SL PRS transmission that may be indicated via Tᵣₑₚ^{SL-PRS}. Note that, similar to a DL-PRS transmission, the repetitions of SL PRS may be interspersed with gaps of size T_{gap}^{SL-PRS} resources such that a gap of T_{gap}^{SL-PRS} resources are inserted between two consecutive repetitions of a SL PRS transmission.

In addition, for mode 1 resource allocation for a SL PRS transmission, the gNB may extend the existing DCI format 3_0 or a new DCI format to allocate and reserve the resources for the SL PRS transmission. A SL PRS resource indication field may be included in the DCI to indicate the allocated/reserved resource for the SL PRS transmission.

In one option, the number of symbols for a PSCCH carrying a SCI format can be (pre-)configured by higher layers. As a further extension, the sl-TimeResourcePSCCH may be reused for the PSCCH in a SL PRS resource pool.

In one option, the number of PRBs or subcarriers can be (pre-)configured by higher layers. Alternatively, the sl-FreqResourcePSCCH may be reused for PSCCH in a SL PRS resource pool. If the number of PRBs is (pre-)configured, the number of REs allocated for the PSCCH, and the associated demodulation reference signal (DMRS) is determined by the number of PRBs and the comb size for the SL PRS transmission.

In addition, for this option, the PSCCH is transmitted starting from the lowest subcarrier of the starting RE offset of the associated SL PRS transmission. The starting RE offset of a SL PRS transmission is determined based on the allocated SL PRS resource index, which can be allocated from the gNB for mode 1 resource allocation mechanism or from the UE for mode 2 resource allocation mechanism for SL PRS transmission.

Further, the existing DMRS pattern may be reused for the PSCCH transmission but is mapped to the REs that are allocated for SL PRS resource. In particular, the DMRS are mapped on every 4^{th} RE allocated for the SL PRS resource or PSCCH transmission.

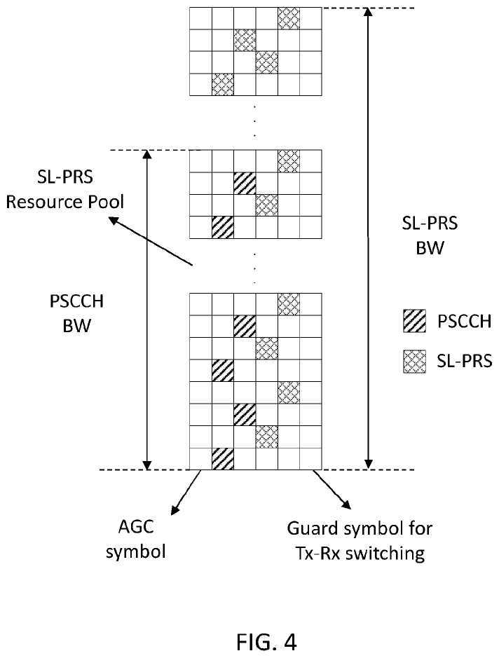

FIG. 4 illustrates a PSCCH transmission inside SL PRS resource for a UE. As shown, the first symbol in the SL PRS resource pool is used for the AGC symbol and the last symbol is allocated as a guard symbol for Tx-Rx switching purposes. A comb size of 4 is configured for the SL PRS transmission. In addition, four SL PRS resources are configured within a SL PRS resource pool, where each SL PRS resource corresponds to a different starting RE offset in the first symbol of the SL PRS transmission.

In addition, two symbols within the SL PRS resource pool are configured for PSCCH transmission. Based on sensing and resource selection, the UE selects first a SL PRS resource, which corresponds to the first starting RE in the comb in the first symbol. In this case, the PSCCH occupies part of the REs allocated for the first SL PRS resource, which spans first two symbols and N subcarriers configured by higher layers.

In some embodiments, a PSCCH carrying a SCI transmission and a SL PRS transmission may be multiplexed in a TDM manner in the same slot.

In one option, both the PSCCH carrying the SCI and SL PRS may be transmitted in a SL PRS resource pool. In particular, a dedicated resource region may be allocated for the PSCCH transmission, which is multiplexed with the SL PRS transmission in a TDM manner.

For this option, the existing physical structure for the PSCCH transmission for SL communication can be reused. Further, the number of symbols and the number of PRBs for the PSCCH transmission may be (pre-)configured by higher layers or based on sl-TimeResourcePSCCH and sl-FreqResourcePSCCH, respectively.

The sub-channel used for the transmission of the PSCCH may be allocated by the gNB for resource allocation mode 1 or selected by the UE for resource allocation mode 2. For the latter case, the UE may select the sub-channel for the PSCCH transmission based on the outcome of sensing and resource selection. In this case, the UE may indicate the SL PRS resource for the SL PRS transmission in the SCI format or based on a pre-defined association rule between the sub-channel and SL PRS resource.

Note that the number of PRBs for the sub-channel for the PSCCH transmission may be different from that configured for the SL communication. In one example, the size of the sub-channel may be same as the number of PRBs configured for the PSCCH transmission.

In another option, the UE may first determine a SL PRS resource for the SL PRS transmission. Further, based on the association between the sub-channel and the SL PRS resource within the SL PRS resource pool, the UE may determine the sub-channel for the PSCCH transmission. The association rule may be defined as one-to-one, many-to-one, or one-to-many, which depends on the number of sub-channels and SL PRS resources within the SL PRS resource pool.

In particular, assuming N_{subch} sub-channels for the PSCCH transmission and N_{SL-PRS} SL PRS resources for the SL PRS transmission, the association can be defined as:

When └N_{SL-PRS}/N_{subch}┘>1, one sub-channel for the PSCCH transmission is mapped to more than one SL PRS resource. In this case, the SL PRS resource for the SL PRS transmission may be indicated in the SCI. The field size may be determined as: log₂(└N_{SL-PRS}/N_{subch}┘).

When └N_{SL-PRS}/N_{subch}┘=1, one sub-channel for the PSCCH transmission is mapped to one SL PRS resource.

When └N_{SL-PRS}/N_{subch}┘<1, more than one sub-channel for the PSCCH transmission is mapped to one SL PRS resource. In this case, the UE may determine the sub-channel for the PSCCH transmission based on the sensing and resource selection outcome.

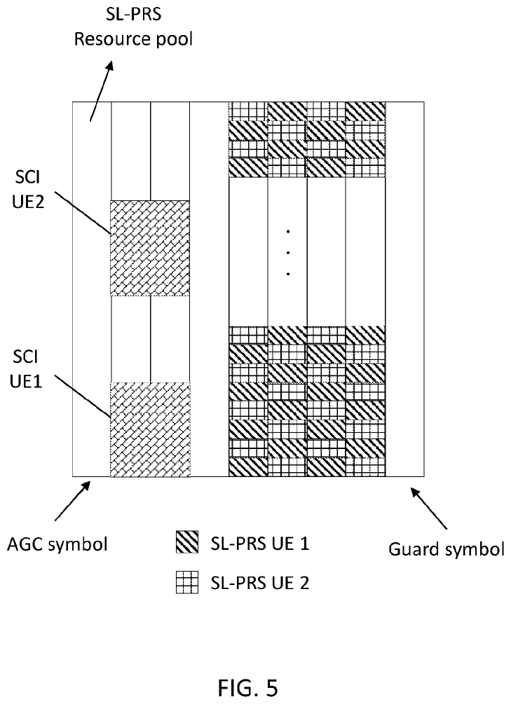

FIG. 5 illustrates an example of multiplexing a PSCCH and SL PRS in a TDM manner in a SL-PSR resource pool in accordance with some embodiments. In the example, within the SL PRS resource pool, the first symbol is used for an automatic gain control (AGC) symbol and the last symbol is allocated for a guard symbol for Tx-Rx switching purposes. Further, the PSCCH is transmitted in the first two symbols after the AGC symbol, and four symbols are allocated for the SL PRS transmission. In the example shown in FIG. 5, a comb size of two is configured for the SL PRS resource pool. Based on the sensing and resource allocation and association between the PSCCH and the SL PRS, UE #1 may select SL PRS resource 1 for the SL PRS transmission and sub-channel 1 for the PSCCH transmission. Similarly, UE #2 may select SL PRS resource 2 for the SL PRS transmission and sub-channel 3 for the PSCCH transmission. Note that in FIG. 5, one guard symbol or AGC symbol is allocated between the PSCCH transmission and SL PRS the transmission.

In another embodiment, a PSCCH carrying a SCI transmission and a SL PRS transmission may be multiplexed in a TDM manner in different slots. In one option, a PSCCH carrying a SCI may be transmitted in a SL communication resource pool while a SL PRS may be transmitted in a SL PRS resource pool. In another option, both a PSCCH carrying a SCI and a SL PRS may be transmitted in a SL PRS resource pool.

For this option, a PSCCH carrying a SCI may be allocated in a sub-channel with or without an associated PSSCH transmission. The time gap between the PSCCH and the initial SL PRS transmission may be indicated in the SCI or (pre-)configured by higher layers. In this case, the initial SL PRS is transmitted in the first slot after the time gap after the PSCCH transmission that is allocated for the SL PRS resource pool. In one example, the time gap may be indicated as 0, which indicates that the initial SL PRS is transmitted in a first slot after the PSCCH transmission that is allocated for the SL PRS resource pool.

Further, the SL PRS resource used for the SL PRS transmission may be indicated in the SCI or determined in accordance with a predefined association rule between sub-channel and SL PRS resource as mentioned above.

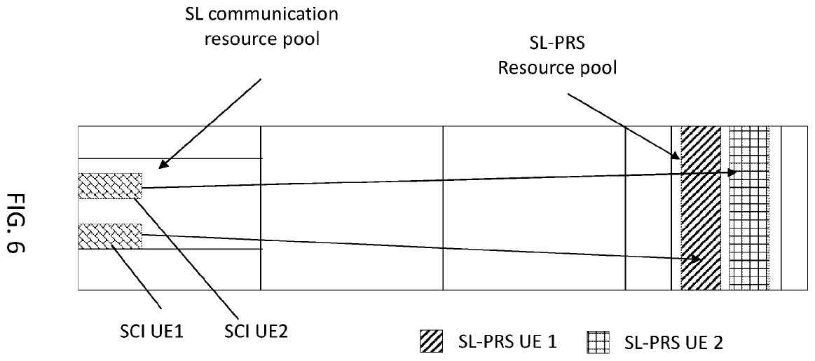

FIG. 6 illustrates one example of multiplexing a PSCCH and a SL PRS in different slots in accordance with some embodiments. In the example shown in FIG. 6, a PSCCH carrying a SCI is allocated in a SL communication resource pool, while a SL PRS is allocated in a SL PRS resource pool. Further, the time gap between the PSCCH and the initial SL PRS transmission is two slots. Based on the sensing and resource allocation and association between the PSCCH and the SL PRS, UE #1 may select sub-channel 1 for the PSCCH and SL PRS resource 1 for the SL PRS transmission. Similarly, UE #2 may select sub-channel 3 for the PSCCH and SL PRS resource 2 for the SL PRS transmission.

In another embodiment, a PSCCH carrying a SCI and a SL PRS may be multiplexed in a combination of a TDM and FDM manner within a SL PRS resource pool. In particular, the PSSCH may occupy some of the PRBs allocated for SL PRS transmission.

For this option, the existing physical structure for the PSCCH transmission for SL communication can be reused. Further, the number of symbols and the number of PRBs for PSCCH transmission may be (pre-)configured by higher layers or based on sl-TimeResourcePSCCH and sl-FreqResourcePSCCH, respectively. Further, the PSCCH is transmitted starting from the lowest subcarrier of the lowest PRB of the associated SL PRS transmission.

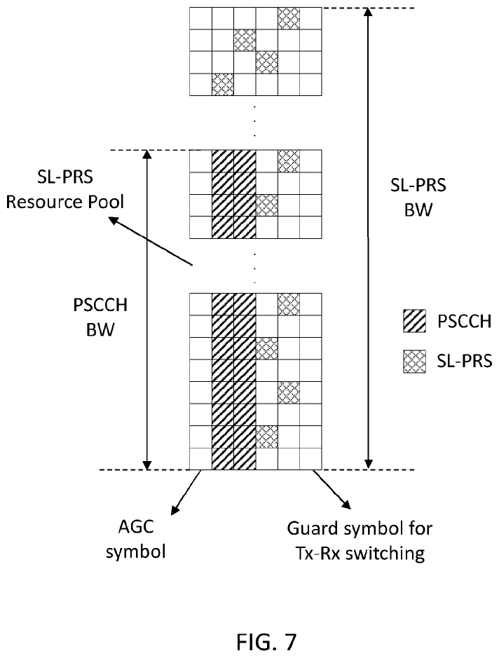

FIG. 7 illustrates one example of multiplexing a PSCCH and a SL PRS in a SL PRS resource pool in accordance with some embodiments. In the example, in the SL PRS resource pool, the first symbol is used for an AGC symbol, and the last symbol is allocated for a guard symbol for Tx-Rx switching purposes. Further, two symbols within the SL PRS resource pool are configured for the PSCCH transmission. In this case, the PSCCH occupies some of the PRBs allocated for the first SL PRS resource, which spans first two symbols and N PRBs configured by higher layers.

In an embodiment, the physical channel structure for a PSCCH associated with a SL PRS transmission without any PSSCH may be same as a PSCCH for a stage-1 SCI for SL communication. Note that the contents of the SCI may be different from a stage-1 SCI defined in Rel-16. For instance, a stage-1 SCI may include one or more of: source ID, destination ID, Zone ID. Analogous to the consideration of communication range requirement indication in a stage-2 SCI, a positioning range requirement based on a coarse estimation of relative locations between a transmitting UE and receiving UEs may be defined and indicated via a stage-1 or stage-2 SCI (latter, if defined for a SCI associated with a SL PRS).

Also, as noted above, the mapping to REs may be different from that of Rel-16 specifications, e.g., aligned to the SL PRS RE mapping.

In another embodiment, the physical channel structure for PSCCH associated with SL PRS transmission without any PSSCH may include both PSCCH for stage-1 and stage-2 SCI. In this case, the PSCCH for stage-2 SCI may be limited to a number of symbols as (pre-)configured or dynamically indicated by the associated stage-1 SCI. In addition, DM-RS symbols for PSCCH for stage-2 SCI may be allocated in specified symbols with respect to the PSCCH with stage-2 SCI; e.g., in the first symbol that may be used for PSCCCH with stage-2 SCI. Further, for PSCCH associated with SL PRS without any PSSCH, the PSCCH for stage-2 SCI may be limited to single layer transmission.

In another embodiment, when the SL PRS is transmitted in a shared resource pool for SL communication and the SL PRS, the SL PRS and the PSSCH/PSCCH may be multiplexed in a TDM manner. In particular, the SL PRS resource index may be indicated in the 2^{nd} stage SCI, which may be carried by the PSSCH. The 2^{nd} stage SCI size is always aligned with the maximum 2^{nd} stage SCI size for the defined SCI format. In some aspects, a fully staggered or partially staggered pattern may be applied for the SL PRS transmission in a shared resource pool. The SL PRS configuration indicated in the 2^{nd} stage SCI may be determined in accordance with one or more following transmission parameters: Number of OFDM symbols with DMRS, allocated number of sub-channels, Sub-channel size, modulation and coding scheme (MCS), Number of transmission layers, 2^{nd} stage SCI beta offset, 2^{nd} stage SCI size, 2^{nd} stage SCI format.

In one option, a SL PRS mapped to a resource pool shared with SL communication signals and/or channels may be mapped after the last symbol of the PSSCH in a slot. In another example, a SL PRS mapped to a resource pool shared with SL communication signals and/or channels may be mapped after the last symbol of the PSFCH in a slot if the PSFCH is mapped to the slot. In this case, the first symbol of the SL PRS may be repeated prior to the SL PRS symbols to serve as the AGC symbol. In yet another example, for a resource pool shared with SL communication signals and/or channels, the SL PRS may be cancelled in a slot with the PSCCH/PSSCH if the PSFCH is also mapped to the slot. In another example of this option, for a resource pool shared with SL communication signals and/or channels, the SL PRS may be cancelled in a slot with the PSCCH/PSSCH if the number of symbols of the PSSCH is larger than a threshold L_{PSSCH} or the number of PSSCH DMRS symbols is larger than a threshold N_{PSSCH-DMRS}, where the values of the thresholds may be specified (e.g., L_{PSSCH}=11, N_{PSSCH-DMRS}=4) or (pre-)configured.

In one option, the starting symbol and/or length of the indicated SL PRS transmission in a shared resource pool may be predefined in the specification or (pre-)configured by higher layers. For the latter case, it may be configured as part of the SL PRS configuration. In one example, the SL PRS transmission may be allocated in the last K symbols in the PSSCH transmission, which may exclude the DMRS symbols associated with PSSCH transmission.

In another option, different configurations of the starting symbol and/or length of the SL PRS transmission configuration may be (pre-)configured and a dynamic indication on which configuration is applied for the SL PRS transmission may be included in the 2^{nd} stage SCI.

In another option, the starting symbol and/or length of the indicated SL PRS transmission in a shared resource pool may be dynamically indicated in the 2^{nd} stage SCI, which may be carried by the PSSCH.

Further, in one option, the starting symbol for the indicated SL PRS transmission is defined relative to the starting symbol of a slot or first symbol of the shared resource pool. Yet in another option, the starting symbol for the indicated SL PRS transmission is defined relative to the ending symbol of the 2^{nd} stage SCI on the PSSCH or the ending symbol of the PSCCH. In one example, the SL PRS may be allocated starting from the ending symbol of the 2^{nd} stage SCI on the PSSCH.

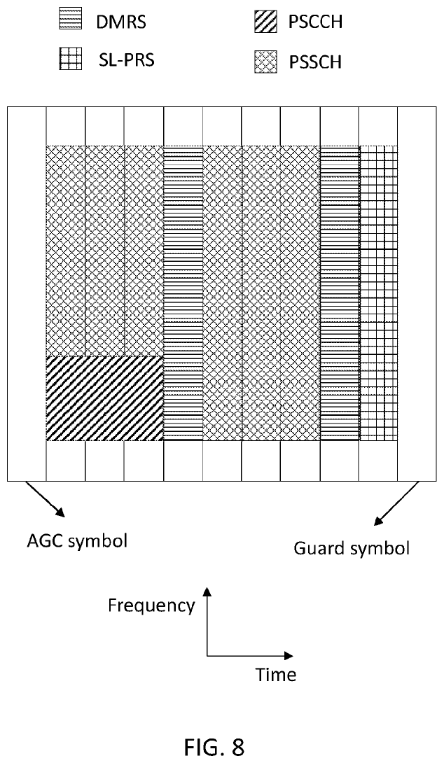

FIG. 8 illustrates one example of multiplexing a SL PRS with a PSSCH and a PSCCH in a shared resource pool in accordance with some embodiments. In the example, a one symbol SL PRS is allocated within the shared resource pool and in the last symbol allocated for the PSSCH transmission. Although a full RE mapping is assumed for the SL PRS transmission in FIG. 8, the design may be straightforwardly extended to the SL PRS transmission with a fully or partially staggered pattern and with more than one symbol.

In another embodiment, when the SL PRS transmission overlaps with the DMRS associated with the PSSCH in a shared resource pool, the SL PRS transmission is cancelled on the overlapped symbol(s). The SL PRS transmission is not further postponed.

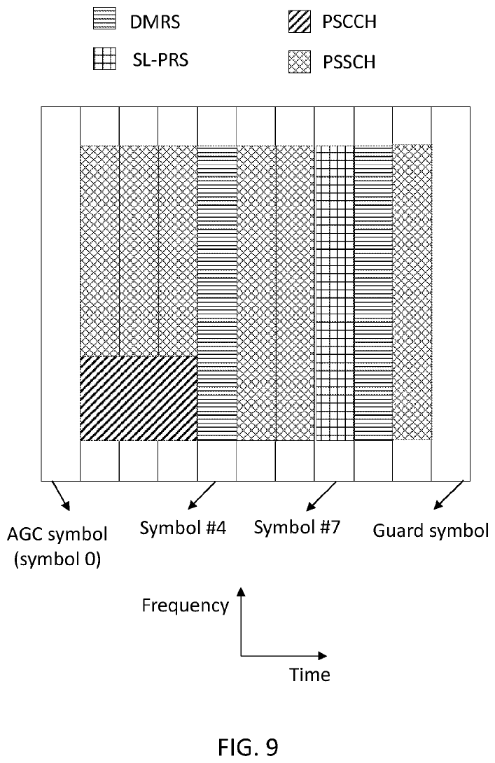

FIG. 9 illustrates one example of collision handling between a SL PRS and a DMRS in a shared resource pool in accordance with some embodiments. In FIG. 9, the SL PRS spans two symbols and starts from symbol #7. Further, the SL PRS overlaps with the DMRS in symbol #8. For this option, the SL PRS transmission is cancelled in symbol #8.

In another option, when the SL PRS transmission overlaps with the DMRS associated with the PSSCH in a shared resource pool, the SL PRS transmission is cancelled on the overlapped symbol(s) and further postponed to the next symbol without the DMRS. In a further example, a postponed SL PRS symbol and any following SL PRS may be cancelled at the slot boundary.

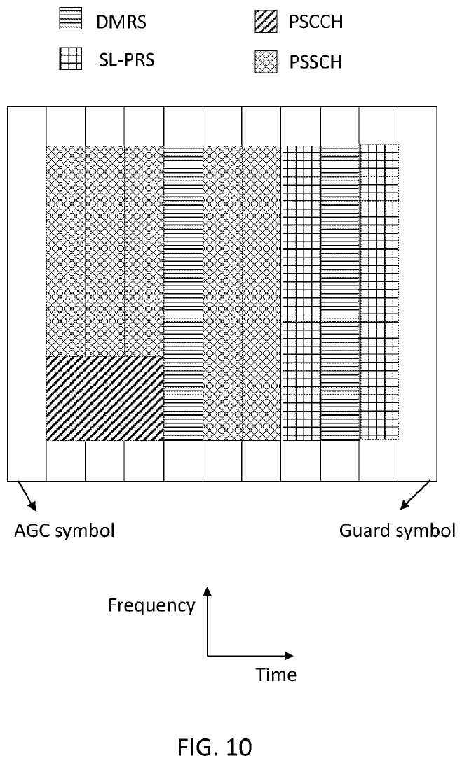

FIG. 10 illustrates one example of collision handling between a SL PRS and a DMRS in a shared resource pool in accordance with some embodiments. In FIG. 10, the SL PRS spans two symbols and starts from symbol #7. Further, the SL PRS overlaps with the DMRS in symbol #8. For this option, the SL PRS is cancelled in symbol #8 and is transmitted in symbol #9 after the DMRS.

In another option, a UE is not expected to receive the SL PRS and the DMRS associated with the PSSCH on the same symbols in a shared resource pool.

In another embodiment, a phase tracking reference signal (PT-RS) associated with the PSSCH is not mapped to the symbols where the SL PRS is transmitted in the shared resource pool. In this case, the PT-RS is dropped in the symbols for the SL PRS transmission.

In another option, the PT-RS associated with the PSSCH is not mapped to resource elements that contain the SL PRS transmission in the shared resource pool. In this case, the PT-RS is dropped or punctured in the resource elements for the SL PRS transmission.

In another option, a UE is not expected to receive the SL PRS and PT-RS associated with the PSSCH on the same resource elements in the shared resource pool.

In another embodiment, when the SL PRS transmission overlaps with REs used for the 2^{nd} stage SCI transmission in a shared resource pool, the SL PRS transmission is cancelled on the overlapped symbol(s). The SL PRS transmission is not further postponed.

In another option, a UE is not expected to receive the SL PRS and REs with the 2^{nd} stage SCI on the same symbols in a shared resource pool.

In another option, when the SL PRS transmission overlaps with REs with the 2^{nd} stage SCI in a shared resource pool, the SL PRS transmission is cancelled on the overlapped symbol(s) and further postponed to the next symbols after the 2^{nd} stage SCI.

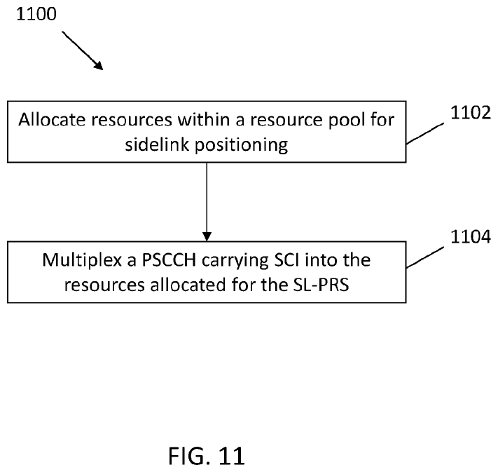

FIG. 11 illustrates a flowchart of multiplexing a PSCCH and a SL PRS in a SL PRS resource pool in accordance with some embodiments. In some embodiments, one or more the electronic devices shown and described herein may be configured to perform one or more processes, techniques, or methods as described herein, or portions thereof. One such process is depicted in FIG. 11. For example, the process 1100 may include, at operation 1102, allocating resources within a resource pool for a SL PRS; and, at operation 1104, multiplexing a PSCCH carrying SCI into the resources allocated for the SL PRS. Other operations, such as those described in the various embodiments above, may be present but are not shown in FIG. 11.

### EXAMPLES

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus for a user equipment (UE), the apparatus comprising:
processing circuitry configured to:
determine that a sidelink position reference signal (SL PRS) is to be transmitted to another UE;
multiplex the SL PRS and a Physical Sidelink Control Channel (PSCCH) transmission that contains sidelink control information (SCI); and
encode, for transmission to the other UE, the multiplexed PSCCH transmission and SL PRS in a particular slot; and
memory configured to store the SL PRS.

22. The apparatus of claim 21, wherein the processing circuitry is further configured to use time division multiplexing (TDM) to multiplex the PSCCH transmission and the SL PRS.

23. The apparatus of claim 21, wherein the processing circuitry is further configured to encode the PSCCH transmission for transmission in a dedicated resource pool for SL PRS that includes a dedicated resource region allocated for the PSCCH transmission.

24. The apparatus of claim 23, wherein a first symbol of the dedicated resource pool for SL PRS is reserved for an automatic gain control (AGC) symbol and a last symbol of the dedicated resource pool is reserved for a guard symbol.

25. The apparatus of claim 21, wherein a number of symbols and a number of physical resource blocks for PSCCH transmission is configured by higher layer signaling.

26. The apparatus of claim 21, wherein a number of symbols and a number of physical resource blocks for PSCCH transmission are based on sl-TimeResourcePSCCH and sl-FreqResourcePSCCH, respectively.

27. The apparatus of claim 21, wherein:
the SL PRS is transmitted in a shared resource pool for SL communication and the SL PRS, and
the SL PRS, the PSCCH transmission, and a Physical Sidelink Shared Channel (PSSCH) are multiplexed using time division multiplexing (TDM).

28. The apparatus of claim 27, wherein a SL PRS resource index is indicated in a second stage SCI carried by the PSSCH.

29. The apparatus of claim 28, wherein a size of the second stage SCI is aligned with a maximum size of the second stage SCI for a defined SCI format.

30. The apparatus of claim 28, wherein a fully staggered or partially staggered pattern is applied for the SL PRS in a shared resource pool.

31. The apparatus of claim 21, wherein at least one of a starting symbol or a length of the SL PRS in a shared resource pool is predefined in a 3GPP specification or configured by higher layer signaling.

32. The apparatus of claim 31, wherein the at least one of the starting symbol or length of the SL PRS is configured as part of a SL PRS configuration.

33. The apparatus of claim 32, wherein the SL PRS is allocated in a last K symbols in a Physical Sidelink Shared Channel (PSSCH) transmission and excludes demodulation reference signal (DMRS) symbols associated with the PSSCH transmission.

34. The apparatus of claim 31, wherein different configurations of the at least one of the starting symbol or length of the SL PRS are configured, and the processing circuitry is further configured to determine a particular configuration of the different configurations to use based on a dynamic indication provided in a second stage SCI.

35. An apparatus for a user equipment (UE), the apparatus comprising:
processing circuitry configured to:
decode, from another UE, a Physical Sidelink Control Channel (PSCCH) transmission and sidelink position reference signal (SL PRS) in a particular slot, the PSCCH transmission and SL PRS being time division multiplexed (TDMed); and
extract sidelink control information (SCI) from the PSCCH transmission; and
memory configured to store the SL PRS.

36. The apparatus of claim 35, wherein the processing circuitry is further configured to decode the PSCCH transmission in a dedicated resource pool for SL PRS that includes a dedicated resource region allocated for the PSCCH transmission.

37. The apparatus of claim 35, wherein:
the SL PRS is transmitted in a shared resource pool for SL communication and the SL PRS,
the SL PRS, the PSCCH transmission, and a Physical Sidelink Shared Channel (PSSCH) transmission are multiplexed using TDM, and
a SL PRS resource index is indicated in a second stage SCI carried by the PSSCH transmission.

38. The apparatus of claim 35, wherein at least one of a starting symbol or a length of the SL PRS in a shared resource pool is predefined in a 3GPP specification or configured by higher layer signaling.

39. A non-transitory computer-readable storage medium that stores instructions for execution by one or more processors of a user equipment (UE), the one or more processors to configure the UE to, when the instructions are executed:
determine that a sidelink position reference signal (SL PRS) is to be transmitted to another UE;
use time division multiplexing (TDM) to multiplex the SL PRS and a Physical Sidelink Control Channel (PSCCH) transmission that contains sidelink control information (SCI) in a particular slot; and
encode, for transmission to the other UE, the multiplexed PSCCH transmission and SL PRS in a particular slot.

40. The non-transitory computer-readable storage medium of claim 39, wherein the instructions, when executed, further configure the one or more processors to cause the UE to send the PSCCH transmission in a dedicated resource pool for SL PRS that includes a dedicated resource region allocated for the PSCCH transmission.
